(19) United States
(12) Patent Application Publication
(10) Pub. No.: US 2011/0169755 A1
(43) Pub. Date: Jul. 14, 2011

(54) Integrated Vehicle Entertainment/Navigation System with Multi-Zone Control

(76) Inventors: MICHAEL SEAN MURPHY, CLEARWATER, FL (US); DAWN ANNE BARKER, CLEARWATER, FL (US)

(21) Appl. No.: 12/987,150

(22) Filed: Jan. 9, 2011

Related U.S. Application Data
(60) Provisional application No. 61/293,381, filed on Jan. 8, 2010.

(51) Int. Cl. G06F 3/041; G09G 5/00

(52) U.S. Cl. 345/173; 345/1.1

(57) ABSTRACT

Various embodiments of computer systems, methods, and computer programs are disclosed for implementing an integrated vehicle entertainment/navigation (IVEN) computer system. One embodiment is an integrated vehicle entertainment and navigation system comprising a central computer, a primary display device, a first secondary display device, a second secondary display device, and a multi-zone configuration module. The central computer is powered by a power source of a vehicle, and comprises a processor and a memory. The primary display device is located in a first zone in the vehicle and is in communication with the central computer. The first secondary display device is located in a second zone in the vehicle and the second secondary display device is located in a third zone in the vehicle. The first and second secondary display devices are in communication with the central computer via a multi-zone hub. The multi-zone configuration module is embodied in the memory of the central computer and executed by the processor. The multi-zone configuration module comprises logic configured to present a multi-zone control menu to the primary display device via a graphical user interface. The multi-zone configuration module further comprises logic configured to selectively control, via the multi-zone control menu presented to the primary display device, access by the first and second secondary display devices to media or applications stored in the memory of the central computer.

### CROSS-REFERENCE TO RELATED APPLICATIONS

This application claims the benefit of the priority of U.S. Provisional Patent Application Ser. No. 61/293,381 filed Jan. 8, 2010 and entitled “Integrated Vehicle Entertainment/Navigation System with Multi-Zone Control,” which is hereby incorporated by reference in its entirety.

### BACKGROUND

Navigation systems and entertainment systems, such as, radios, gaming consoles, multimedia players, and web-connected devices are commonplace in vehicles. Despite the commercial success of such systems, however, there are significant limitations to existing solutions. For example, navigation and entertainment systems are typically provided as independently controlled systems with the navigation features provided to an in-dash display and the entertainment features provided to detached rear seat displays. Thus, there is a need in the industry for improved computer systems, methods, and computer programs for providing entertainment and navigation functionality in vehicles.

### SUMMARY

Various embodiments of computer systems, methods, and computer programs are disclosed for implementing an integrated vehicle entertainment/navigation (IVEN) computer system. One embodiment is an integrated vehicle entertainment and navigation system comprising a central computer, a primary display device, a first secondary display device, a second secondary display device, and a multi-zone configuration module. The central computer is powered by a power source of a vehicle, and comprises a processor and a memory. The primary display device is located in a first zone in the vehicle and is in communication with the central computer. The first secondary display device is located in a second zone in the vehicle and the second secondary display device is located in a third zone in the vehicle. The first and second secondary display devices are in communication with the central computer via a multi-zone hub. The multi-zone configuration module is embodied in the memory of the central computer and executed by the processor. The multi-zone configuration module comprises logic configured to present a multi-zone control menu to the primary display device via a graphical user interface. The multi-zone configuration module further comprises logic configured to selectively control, via the multi-zone control menu presented to the primary display device, access by the first and second secondary display devices to media or applications stored in the memory of the central computer.

Another embodiment is a method for providing entertainment in a vehicle. One such method comprises: a central computer in a vehicle presenting a multi-zone control menu to a primary display device located in a first zone in the vehicle; a user of the primary display device specifying, via the multi-zone control menu, access permissions for services provided by the central computer to a first secondary display device located in a second zone and a second secondary display device located in a third zone; and based on the specified access permissions for the second zone and the third zone, controlling access to the services by the first and second secondary display devices.

### BRIEF DESCRIPTION OF THE DRAWINGS

FIG. 1 is a block diagram illustrating an embodiment of vehicle entertainment and navigation system.

FIG. 2 is a block diagram illustrating an embodiment of the integrated vehicle entertainment/navigation computer system of FIG. 1.

FIG. 3 is a flowchart illustrating the architecture, operation, and/or functionality of an embodiment of the multi-zone configuration and control modules of FIG. 2.

FIG. 4a is a screenshot of an embodiment of a multi-zone configuration menu presented via a graphical user interface to a primary display device by the integrated vehicle entertainment/navigation computer system for enabling a user to configure one or more zones associated with one or more corresponding secondary display devices.

FIG. 4b illustrates the screenshot of FIG. 4a in which a user has selected a zone and initiated a zone configuration menu.

FIG. 4c illustrates the screenshot of FIG. 5 in which the user has selected a permissions parameter and initiated a zone permissions menu.

FIG. 5 is a data diagram illustrating an exemplary data structure for configuring and controlling a multi-zone control feature via the integrated vehicle entertainment/navigation computer system of FIGS. 1 and 2.

FIG. 6 is a flowchart illustrating another embodiment of the multi-zone configuration and control modules of FIG. 2.

FIGS. 7a & 7b are a combined flowchart illustrating a further embodiment of the multi-zone configuration and control modules of FIG. 2.

### DETAILED DESCRIPTION

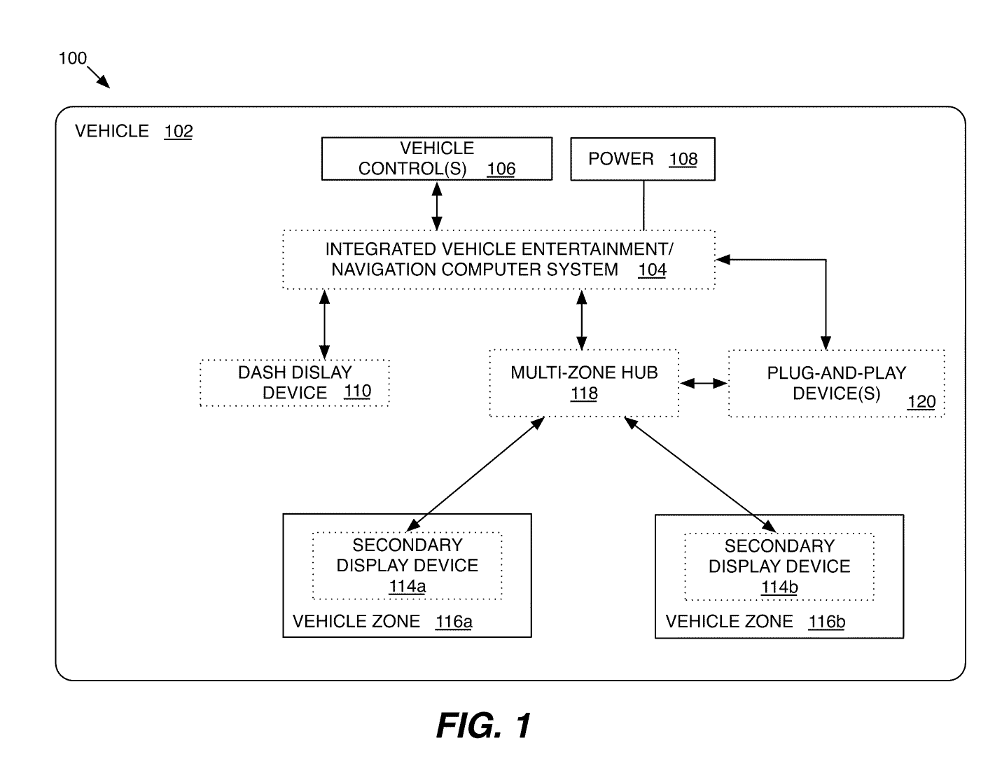

Various embodiments of computer systems, methods, and computer programs are disclosed for implementing an integrated vehicle entertainment/navigation (IVEN) system with multi-zone configuration and control. Various exemplary embodiments are described below in detail with reference to FIGS. 1-7 and the subject matter described and illustrated in the Appendix. As an introductory matter, an exemplary IVEN computer system will be described. In general, the IVEN system comprises a special-purpose central computer configured to selectively configure, control and provide various interactive features to a plurality of standalone display devices located in the vehicle. It should be appreciated that one or more of the central computer and the display devices may be factory installed by a vehicle manufacturer or installed as after-market components.

The central computer may be configured to provide any desirable features to the display devices, such as, for example, audio and/or video playback either locally or via the Internet, a satellite transceiver, radio transceiver, wireless transceiver, or external multimedia devices, GPS navigation, gaming, web-based services, or any other entertainment, navigation, or other desirable features. The central computer supports a multi-zone feature that enables a user of one of the display devices (referred to as a primary display device, which may comprise, for example, an in-dash display device) to selectively control access to the central computer system by one or more of the other display devices (referred to as secondary display devices). The secondary display devices may be located in separate locations (referred to as “zones”) of the vehicle. In an embodiment, the secondary display devices may be installed in the rear of the front seat headrests, second row seats, or otherwise installed or located in the vehicle. The central computer presents a control menu to the primary display device. The control menu enables the user to interactively control whether and/or to what extent a secondary display device is permitted to access data, applications, and/or features provided by the central computer. For example, in operation, the user of the primary display device may select a particular zone (which is associated with a corresponding secondary display device) and configure various access and/or configuration parameters. It should be appreciated that the multi-zone feature may support any of the following or other parameters, roles, permissions, etc.: enable/disable a secondary display; enable/disable one or more applications; enable/disable features provided by an application; application configuration parameters; multimedia types; and individual multimedia resources or files.

FIG. 1 generally illustrates a computer system 100 for implementing an IVEN system in a vehicle 102. The computer system 100 comprises a central computer (e.g., IVEN computer system 104), a primary display device (e.g., in-dash display 110), and one or more secondary display devices 114. The primary display device and the secondary display devices 114 may communicate with the central computer via wired and/or wireless connections. It should be appreciated that the wireless or wired connections may support any suitable communication or physical standards, protocols, etc. In one embodiment, the secondary display devices 114 communicate with the IVEN computer system 104 via a multi-zone hub 118 configured to split signals (e.g., audio and/or video signals) from the IVEN computer system 104. As illustrated in FIG. 1, each secondary display device 114 corresponds to a particular vehicle zone 116.

The IVEN computer system 104 may be powered by an internal power source or via a connection to a vehicle power source 108. The IVEN computer system 104 may also connect to one or more vehicle controls 106. In this regard, the IVEN computer system 104 may be installed as an after-market accessory by connecting the IVEN computer 104 to, for example, the vehicle radio stack. As further illustrated in FIG. 1, one or more plug-and-play devices 120 (e.g., a gaming console, a multimedia player, etc.) may be connected to the IVEN computer system 104 or the multi-zone 118 to further enhance the services provided to the display devices.

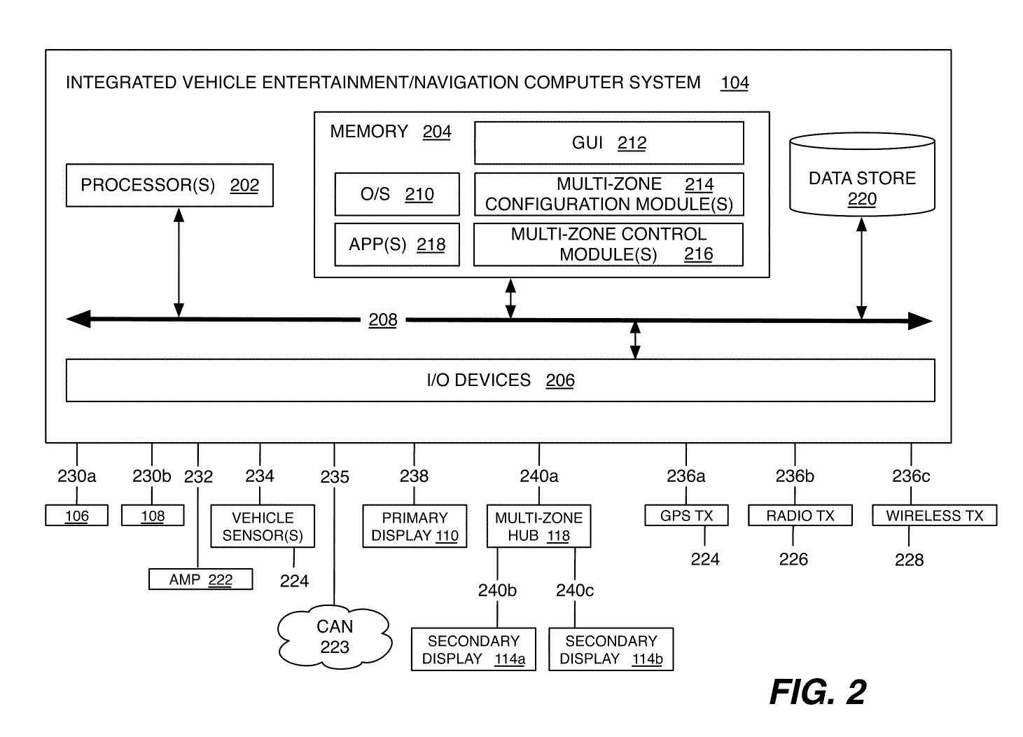

Referring to FIG. 2, the IVEN computer system 104 may comprise one or more processor(s) 202, a memory 204, a data store 220, and input/output (I/O) devices 206 interconnected via a local interface 208. The memory 204 may store the software associated with the computer system that is executed by the processor(s) 202. In the embodiment of FIG. 2, the memory 204 comprises an operating system 210, a graphical user interface 212, one or more applications 218 for providing entertainment, navigation, or other functionality, multi-zone configuration module(s) 214, and multi-zone control module(s) 216. The data store 220 may store multimedia resources, files, etc. or other data associated with the operation of the IVEN computer system 104. As described below in more detail, the multi-zone configuration module(s) 214 generally comprise the logic and/or functionality for enabling users to configure the multi-zone access/permissions, and the multi-zone control module(s) 216 generally comprise the logic and/or functionality for controlling access to the IVEN computer system 104 according the multi-zone access permissions.

The multi-zone configuration module(s) 214 and the multi-zone control module(s) 216 may be implemented in software, hardware, firmware, or a combination thereof. In embodiment illustrated in FIG. 2, the modules are implemented in software or firmware that is stored in the memory 204 and that is executed by a suitable instruction execution system (e.g., processor(s) 202). In software or firmware embodiments, the logic may be written in any suitable computer language. In hardware embodiments, the modules may be implemented with any or a combination of the following, or other, technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

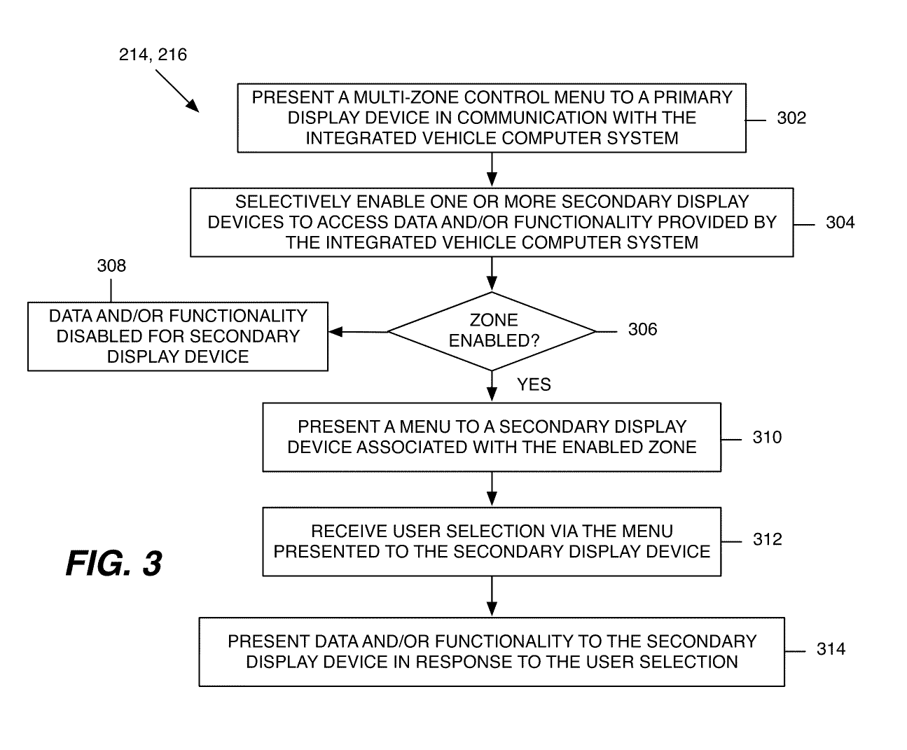

Furthermore, the descriptions of the multi-zone configuration module(s) 214 and the multi-zone control module(s) 216 or blocks associated with any illustrated flowcharts, including FIGS. 3, 6, and 7, may represent modules, segments, logic or portions of code which include one or more executable instructions for implementing logical functions or steps in the process. It should be further appreciated that any logical functions may be executed out of order from that shown or discussed, including substantially concurrently or in reverse order, depending on the functionality involved, as would be understood by those reasonably skilled in the art. Furthermore, the multi-zone configuration module(s) 214 and the multi-zone control module(s) 216 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain or store in a tangible medium the program for use by or in connection with the instruction execution system, apparatus, or device.

As mentioned above, the IVEN computer system 104 may be implemented as an after-market assembly that may be conveniently installed in the vehicle 102. The IVEN computer system 104 may be physically separated from the display devices for ease of installation in different styles of vehicles. The IVEN computer system 104 may be connected to the multi-zone hub 118 and the primary display device via an all-in-one connector by which all inputs and outputs to and from each display device is handled through one single cable. The signals may include, for example, video, audio, USB, power, etc. The multi-zone hub 118 may support both input and output of, for example, video, audio, and USB data.

The I/O devices 206 may support any suitable data connectors, signaling, etc. depending on the participant functionality and features supported by the IVEN computer system 104. In the embodiment illustrated in FIG. 2, the IVEN computer system 104 may connect to the vehicle control(s) 106 (e.g., break control, contacts, lights, etc.) and the vehicle power 108 via a power connector 230. A connection to an amplifier 222 may comprise an audio connector 232. Vehicle sensors 224 (e.g., tire pressure monitors, cameras, etc.) may connect via a USB connector 234. The IVEN computer system 104 may also support connections to other devices supporting the controller area network (CAN) vehicle bus standard or other vehicle standards, such as, OBD-II via a connection 235. The connection to the multi-zone hub 118 may comprise a TV-out/USB connector 240, which may also be used to connect the secondary display devices 114 to the multi-zone hub 118. The primary display device may connect to the IVEN computer system 104 via, for example, a VGA/USB/power connection 238. A GPS transceiver 224, a radio transceiver 226, and a wireless transceiver 228 may communicate with the IVEN computer system via a connection 236 (e.g., antenna). It should be appreciated that the data connections and signaling may be implemented in alternative ways. Further exemplary embodiments are illustrated and described in the attached Appendix.

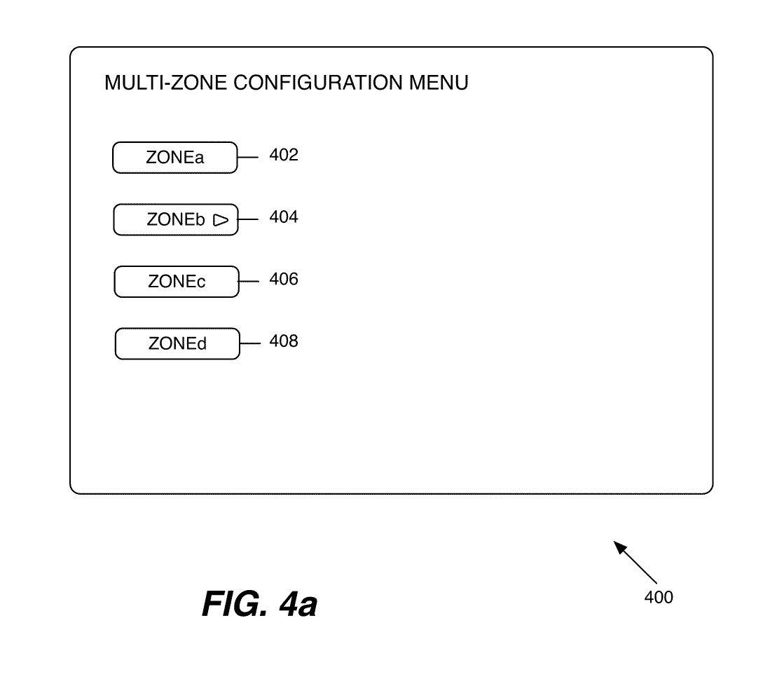

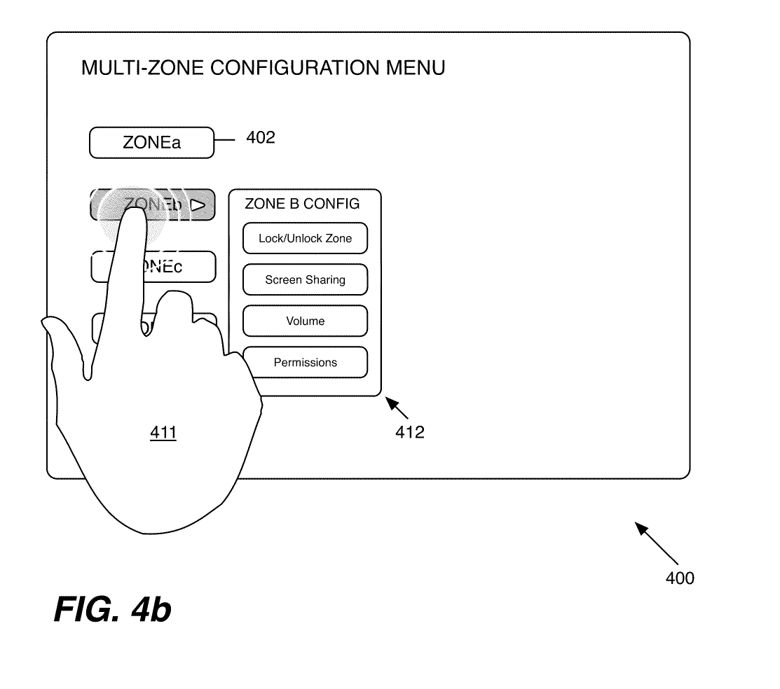

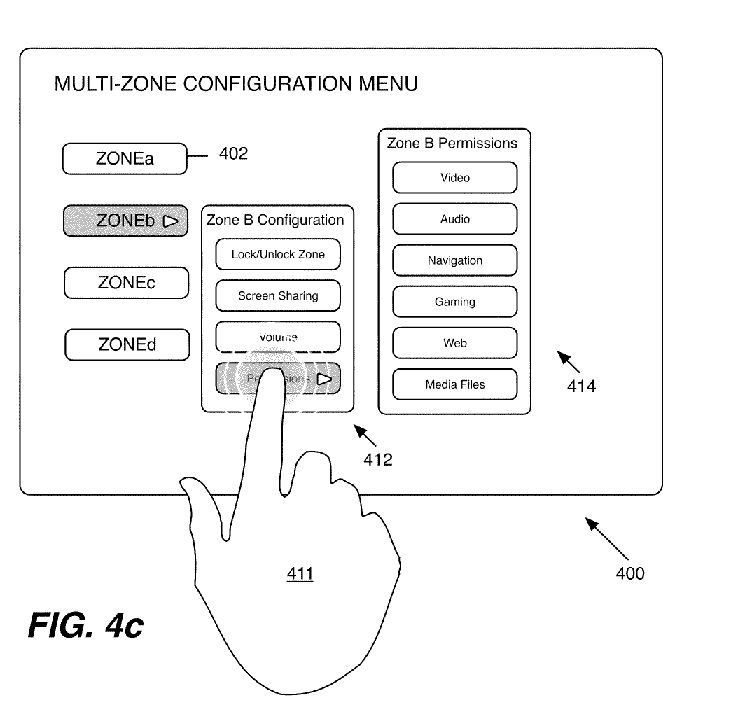

Referring to FIGS. 3-7, various embodiments of the multi-zone features supported by the IVEN computer system 104 will be described. FIG. 3 illustrates various aspects of one embodiment of the multi-zone feature. At block 302, the IVEN computer system 104 presents a multi-zone control menu to a primary display device (e.g., a touch screen display device). FIGS. 4a-4c illustrate an example of a multi-zone control menu 400 presented via the graphical user interface 212. The multi-zone control menu 400 may display a user interface component associated with one or more zones 116. The example of FIG. 4a displays a component 402 for a zone 116a, a component 404 for a zone 116b, a component 406 for a zone 116c, and a component 404 for a zone 116d. At block 304, a user 411 (FIGS. 4b & 4c) may select one of the user interface components associated with a particular zone. In FIG. 4b, the user has selected the component 404 for zone 116b. The user selection of the component 404 (e.g., via the touch screen display or otherwise via an input command to the device) initiates the display of a zone configuration menu 412.

As illustrated in FIG. 4b, the zone configuration menu 412 may prompt the user 411 to specify one or more access, permission, or other parameters related to the zone 116b. A lock/unlock zone toggle may enable the user 411 of the primary display device to conveniently enable and disable the secondary display device 114b from accessing the IVEN computer system 104. As mentioned above, it should be appreciated that the zone configuration menu 412 may enable/disable all access by the secondary display device 114b or selectively configure various permissions, parameters, etc. For example, the volume for zone 116b may be controlled via a volume set component. A permissions component may trigger a zone permissions menu 414 that enables the user 411 to control access to specific applications 218, devices, multimedia resources or files, etc. and/or specify additional application-specific parameters. In FIG. 4c, the zone permissions menu 414 comprises a video permissions component, an audio permissions component, a navigation permissions component, a gaming permissions component, and a web permissions component. Each permissions component may be configured with an enable/disable toggle to conveniently lock/unlock access to the particular feature, or the component may be selected to display further menus that enable the user 411 to configure parameters specific to a particular application 218. The user 411 may also selectively grant access to media resources or files stored in the data store 220 by, for example, selecting from a list of resources or based on media type, genre, artist, classification, content type, etc.

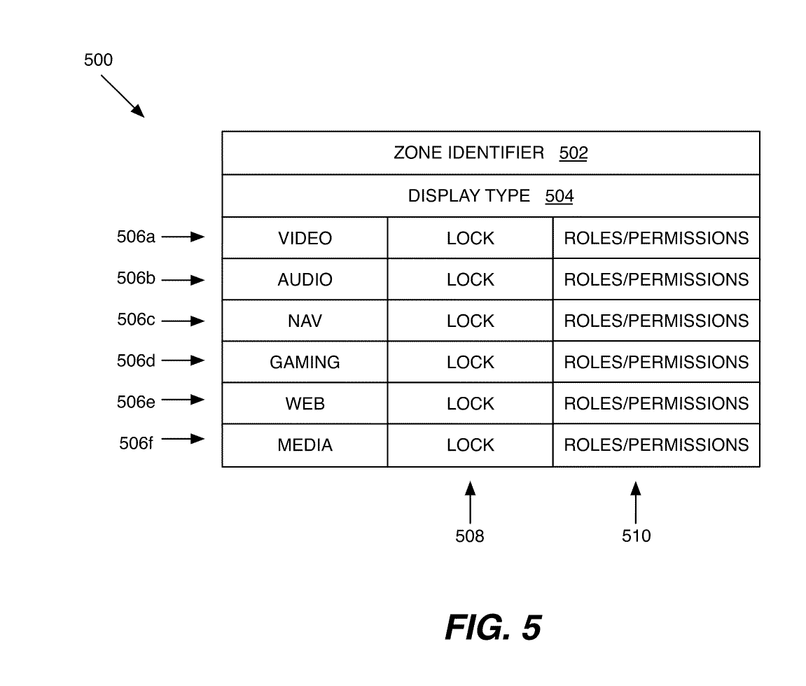

FIG. 5 illustrates an exemplary data structure 500 for storing the access or permissions for zones 116 in the data store 220 or memory 204. Each zone 116 may have a zone identifier 502 associated with the corresponding secondary display device. A display type field 504 may store information about the secondary display device 114 (e.g., type, resolution, size, or other hardware/software specifications). A plurality of data fields 506 may store the access or permissions parameters associated with the corresponding application 218. For example, a video permissions field 506a may have a lock/unlock status field 508 and various control parameters (e.g., roles/permissions parameters 510).

Referring again to FIG. 3, after the user 411 configures a zone 116 (or based on default configurations), the IVEN computer system 104 determines whether a zone 116 is enabled (decision block 306). If a zone 116 is disabled, the IVEN computer system 104 does not enable the corresponding secondary display device 114 to access data and/or functionality. If the zone 116 is enabled, the IVEN computer system 104 may enable the secondary display device 114 to access the system. At block 310, the IVEN computer system 104 may present a suitable menu to the secondary display device 114, which enables access to data and/or functionality of the IVEN computer system 104. At block 312, the IVEN computer system 104 may receive user selections via the presented menu and, at block 314, present the requested data and/or functionality in accordance with the configuration parameters discussed above.

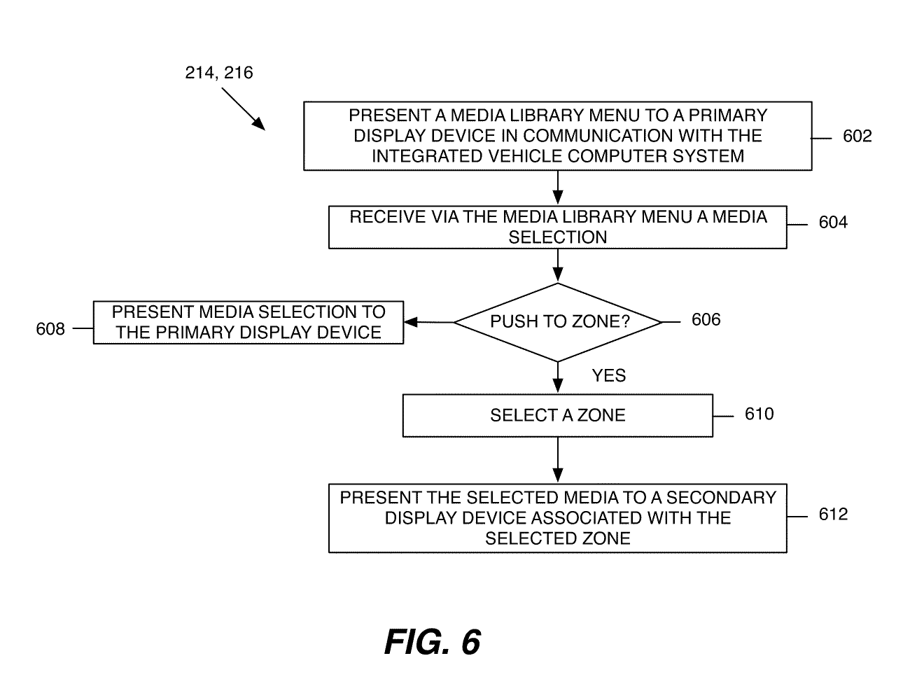

FIG. 6 illustrates the operation of a multi-zone feature that enables media to be pushed to the secondary display devices 114 from the primary display device. At block 602, the IVEN computer system 104 presents a media library menu to the primary display device from which a media resource may be selected (block 604). After the media resource is selected, the user may control whether the media resource is to be pushed to one or more secondary display devices 114 (decision block 606). The media selection may be presented to the primary display device, at block 608. If the push feature is enabled, the media selection is determined and one or more zone selections are determined (block 610). At bloc 612, the IVEN computer system 104 presents the media selection to the secondary display devices 114 associated with the zone selections.

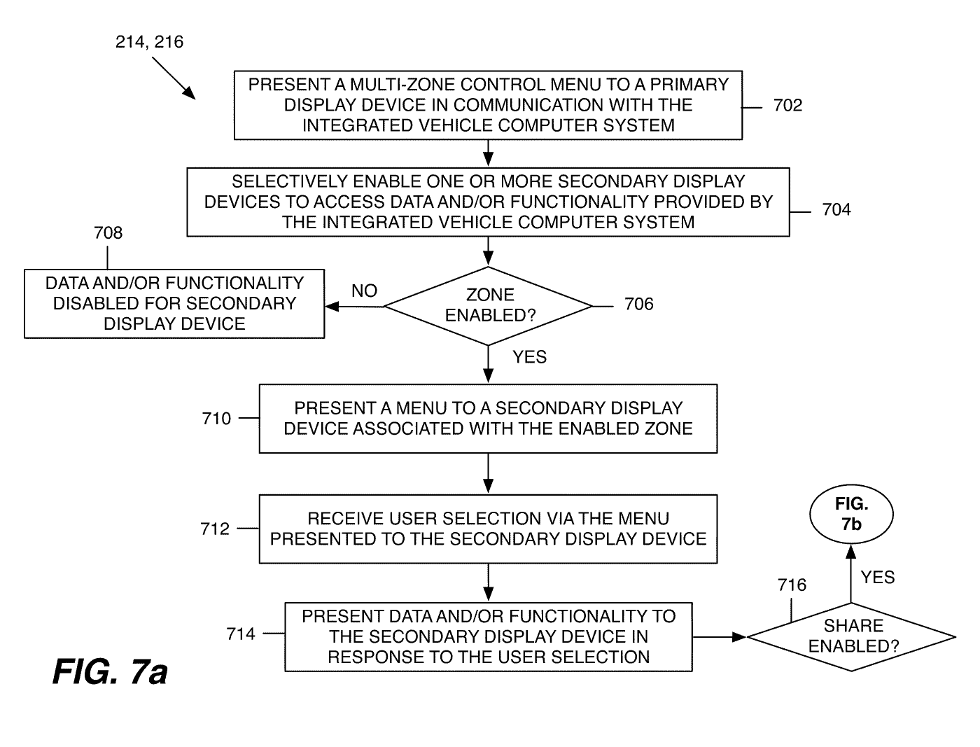

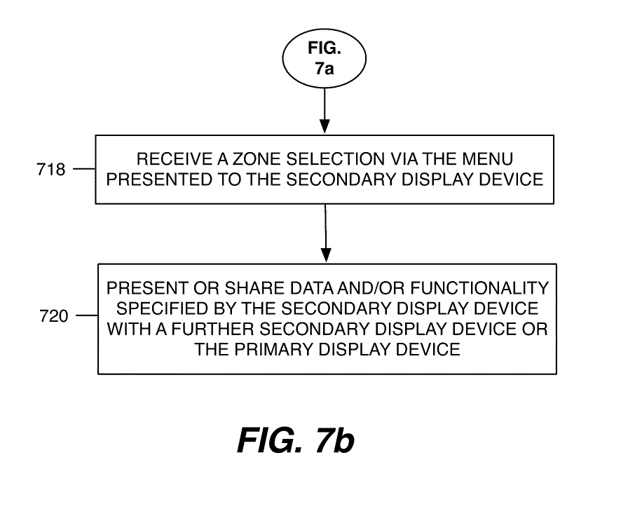

FIGS. 7a & 7b illustrate the operation of a further multi-zone feature that enables the secondary display devices 114 to share data and/or functionality or otherwise communicate with each other or the primary display device via the IVEN computer system 104. Access to the sharing feature may be initiated and/or controlled by, for example, the multi-zone configuration menu 400 described above (e.g., screen sharing component illustrated in FIG. 4c).

At block 702, the IVEN computer system 104 presents a multi-zone control menu to the primary display device. Via the control menu, At block 704, the IVEN computer system 104 selectively enables one or more secondary display device 114 to access data and/or functionality provided by the system. If a zone is enabled (decision block 706), the IVEN computer system 104 may present an interactive menu to the corresponding secondary display device 114 (block 710). The interactive menu provides a user interface mechanism for selecting or otherwise accessing data and/or functionality and presenting it to the secondary display device 114 (blocks 712 and 714). As illustrated at decision block 716, if the sharing feature is enabled for the secondary display device 114, a user may specify a zone selection (block 718) for one of the other display devices and share the corresponding data and/or functionality (block 720).

Various embodiments of additional features and functions of the IVEN computer system 104 are illustrated and described in the attached Appendix with reference to further user interface screenshots for the primary display device and the secondary display devices 114.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. An integrated vehicle entertainment and navigation system comprising:
a central computer powered by a power source of a vehicle, the central computer comprising a processor and a memory;
a primary display device located in a first zone in the vehicle and in communication with the central computer;
a first secondary display device located in a second zone in the vehicle and a second secondary display device located in a third zone in the vehicle, the first and second secondary display devices in communication with the central computer via a multi-zone hub; and
a multi-zone configuration module embodied in the memory of the central computer and executed by the processor, the multi-zone configuration module comprising:
logic configured to present a multi-zone control menu to the primary display device via a graphical user interface; and
logic configured to selectively control, via the multi-zone control menu presented to the primary display device, access to media or applications stored in the memory of the central computer by the first and second secondary display devices.

2. The integrated vehicle entertainment and navigation system of claim 1, wherein the primary display comprises an in-dash device.

3. The integrated vehicle entertainment and navigation system of claim 1, wherein the primary display device and the central computer are connected to the multi-zone hub via an all-in-one connector.

4. The integrated vehicle entertainment and navigation system of claim 1, wherein the first and secondary display devices communicate with the central computer via a wireless connection to the multi-zone hub.

5. The integrated vehicle entertainment and navigation system of claim 1, wherein one or more of the primary display device and the first and second secondary display devices comprise a touch screen display.

6. The integrated vehicle entertainment and navigation system of claim 1, wherein the multi-zone hub is further in communication with one or more plug-and-play devices.

7. The integrated vehicle entertainment and navigation system of claim 6, wherein the plug-and-play devices comprises at least one of a gaming console, a multimedia player, and a GPS navigation device.

8. The integrated vehicle entertainment and navigation system of claim 1, wherein the logic configured to selectively control access to the media or applications stored in the memory of the central computer by the first and second secondary display devices comprises:
logic configured to selectively lock and unlock at least one of the first and second zones.

9. The integrated vehicle entertainment and navigation system of claim 1, wherein the logic configured to selectively control access to the media or applications stored in the memory of the central computer by the first and second secondary display devices comprises:
logic configured to selectively specify access permissions for at least one of the first and second zones.

10. The integrated vehicle entertainment and navigation system of claim 1, wherein the access permissions control access to a plug-and-play device connected to the multi-zone hub.

11. The integrated vehicle entertainment and navigation system of claim 1, wherein the multi-zone configuration module further comprises:
logic configured to enable sharing of the media or applications between the first and second zones.

12. The integrated vehicle entertainment and navigation system of claim 1, wherein the multi-zone configuration module further comprises:
logic configured to present a media library menu to the primary display device;
logic configured to receive a media selection via the media library menu; and
logic configured to present the media selection to at least one of the first and second secondary display devices without presenting the media selection to the primary display device.

13. A method for providing entertainment in a vehicle, the method comprising:
a central computer in a vehicle presenting a multi-zone control menu to a primary display device located in a first zone in the vehicle;
a user of the primary display device specifying, via the multi-zone control menu, access permissions for services provided by the central computer to a first secondary display device located in a second zone and a second secondary display device located in a third zone; and
based on the specified access permissions for the second zone and the third zone, controlling access to the services by the first and second secondary display devices.

14. The method of claim 13, further comprising connecting the central computer and the first and second secondary display devices to a multi-zone hub that provides communication between the central computer and the first and second secondary display devices.

15. The method of claim 14, wherein the primary display device comprises an in-dash display device in communication with the central computer.

16. The method of claim 14, wherein the connecting the central computer and the first and second secondary display devices to the multi-zone hub comprises installing the multi-zone hub in the vehicle and connecting the central computer and the first and second secondary display devices to the multi-zone hub via an all-in-one connector.

17. The method of claim 13, wherein the specifying the access permissions comprises selectively locking and unlocking at least one of the second and third zones.

18. The method of claim 13, wherein the specifying access permissions for the second and third zones comprises specifying one or more of video permissions, audio permissions, navigation permissions, gaming permissions, web permissions, and media file permissions.

19. The method of claim 13, further comprising selectively enabling the first and second secondary display devices to interact with each other.

20. The method of claim 13, further comprising the user of the primary display device pushing a selected media file to at least one of the first and second secondary display devices.
